(19) United States
(12) Patent Application Publication
(10) Pub. No.: US 2005/0241427 A1
(43) Pub. Date: Nov. 3, 2005

(54) Bike hand brake cable

(76) Inventor: Szu-Fang Tsai, Chang-Hua Hsien (TW)

Correspondence Address: Leong C. LEI, PMB#1008, 1867 Ygnacio Valley Rd., Walnut Creek, CA, 94598, US

(21) Appl. No.: 10/834,916

(22) Filed: Apr. 30, 2004

(51) Int. Cl. F16C 1/10

(52) U.S. Cl. 74/502.2

(57) ABSTRACT

A bike hand brake cable is guide by an arch contact of a brake level of the bike to keep the cable on the same axis when the brake level is pulled so to provide a direct and safe braking free of misaligned cable, or component force, or breakup due to wear and tear; and to save efforts on pulling the cable with increased pull distance by increasing the binding circumference of the cable against the arch contact for the cable when pulled to circuit the arch contact.

### BACKGROUND OF THE INVENTION

(a) Technical Field of the Invention

The present invention is related to a structure of a bike hand brake cable, and more particularly, to one where, when the brake level is pulled to apply a hand braking, the cable is kept on the same axis by guiding the cable with an arch contact on the brake level to produce direct and effective pulling of the cable and easier braking with increased pull distance of the cable.

(b) Description of the Prior Art

Referring to FIG. 1 of the accompanying drawings, a bike brake level 1 of the prior art has a concave 13 provided in the front of a recess 12 accommodating a head 111 of the brake cable 11 for the space defined by the concave 13 to prevent the cable 11 from being deflected to where below a pull axis to affect the braking due to confrontation or locking when the cable 11 is pulled by the hand level 1 in the course of applying a hand braking.

When the hand level 1 is pulled and turned, the brake cable 11 will be deflected to where below the axis of the pull, and a component force will be created during the braking. Accordingly, the rider has to apply more force to brake the bike and that presents a safety concern for a child or woman rider who has smaller palms while attempting a hand brake. Furthermore, when the brake cable 11 is deflected downward, friction is created between the brake cable 11 and an inner opening 14 at the head of the brake level 1. Frequent friction will cause the brake cable 11 to be vulnerable to a sudden breakup.

### SUMMARY OF THE INVENTION

The primary purpose of the present invention is to provide an improved arrangement of the brake cable of a brake level of a bike that allows direct and safe pulling of the brake cable in applying a hand brake. To achieve the purpose, an arch contact of the brake level is used to guide the brake cable for the brake cable to be maintained on the same axis during the application of a hand brake so to prevent any sudden breakup of the brake cable due to frequent friction, component force or deflection.

Another purpose of the present invention is to provide an improved arrangement of the brake cable of a brake level of a bike that allows easier application of applying a hand brake. To achieve the purpose, the circumference of the arch contact for the brake cable to bind against is increased for the brake cable to produce the pull by circuiting the circumference of the arch contact so to increase the pull distance to save efforts in applying a hand brake when compared to a down slope and suspended straight line pull of the brake cable of the prior art.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a hand brake level of a bike of the prior art.

FIG. 2 is an exploded view of the present invention.

FIG. 3 is a perspective view of the present invention.

FIG. 4 is a schematic view of the present invention before applying a hand brake.

FIG. 5 is a schematic view of the present invention after applying a hand brake.

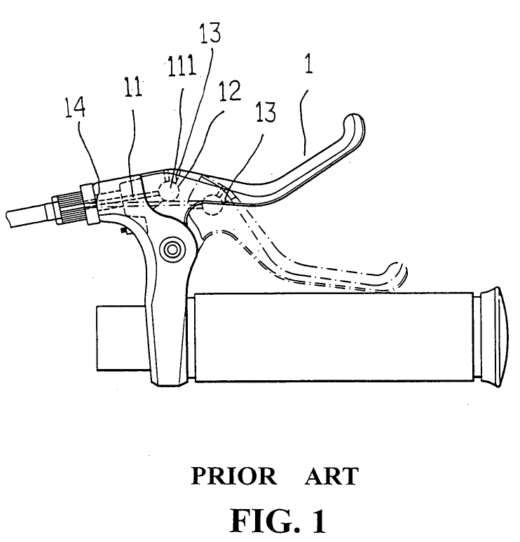

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

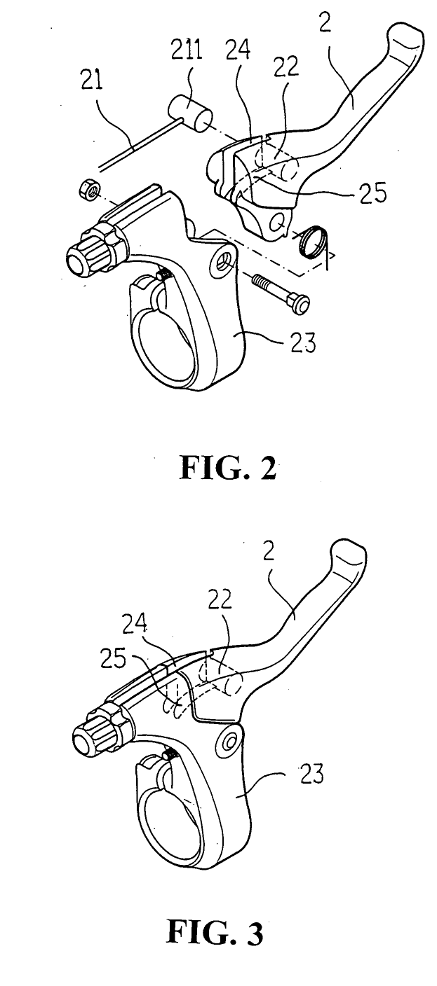

Referring to FIGS. 2 and 3, an arrangement of a bike brake cable to a hand brake level of the present invention is essentially comprised of a brake level 2, a brake cable 21, a cable head 211, a recess 22, and a locking base 23. Wherein, an arch contact 25 is provided at the recess 24 to accommodate the brake cable 21 for the brake cable 21 to bind flushed over the arch contact 25 when the hand brake is applied. Accordingly, when the brake level 2 is turned to apply the hand brake, the brake cable 21 is maintained on the same axis to not only allow a direct, efforts saving and effective pull of hand brake, but also permit increased pull distance of the brake cable 21.

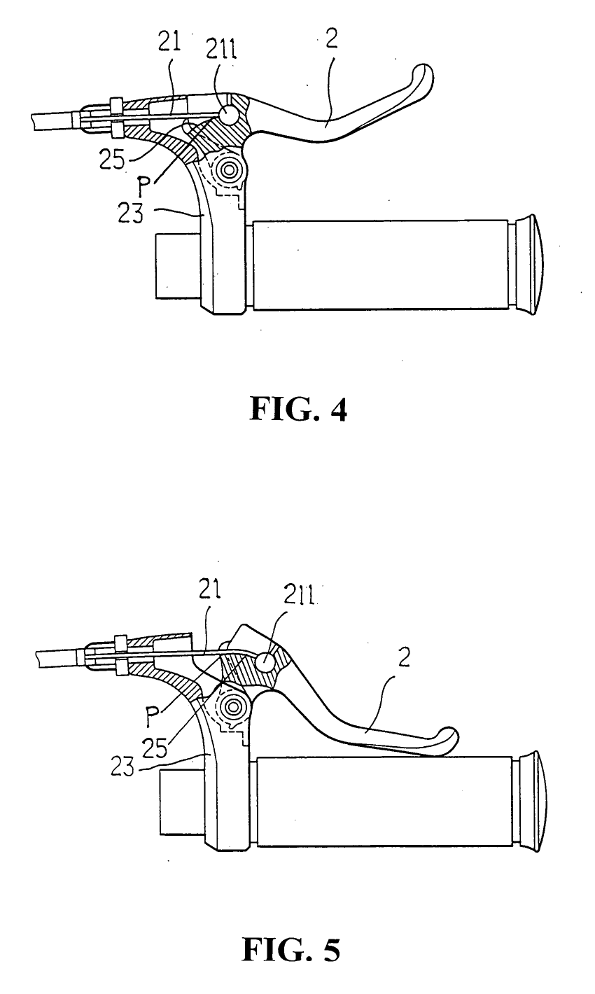

As illustrated in FIG. 4 when the brake level 2 is not applied, the cable head 211 of the brake cable 21 is locked in the recess 22 while the brake cable 21 indicates a straight-line strained status.

Now referring to FIG. 5, when the hand brake is applied, the brake level is pressed and turned for the brake cable 21 at the approximate end to the cable head 211 is close flushed over the arch contact 25 to exercise a circumferential pull. Accordingly, the brake cable 21 is given a longer pull distance (i.e. displacement amount), and there is no risk of generating any component force since a point P on the surface of the arch contact 25 gradually holding flushed against the brake cable 21 in the course of applying the brake level 21 relates to the function of force on the same axis with that for the brake cable 21 coming from ahead for the brake cable 21 to produce a direct, effective and efforts saving hand brake.

The present invention by providing an arch contact at the brake level in the arrangement of a bike hand brake cable to enable the brake cable in the course of applying a hand brake to bind flushed over the arch contact, thus to be maintained on the same axis when pulled when the brake level is turned. Consequently, while providing a direct, efforts saving and effective hand brake on the brake cable, an increased pull distance of the brake cable is achieved. Therefore, this application for a utility patent is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An arrangement of a bike hand brake cable to apply a safe, direct and easier hand braking with increased pull distance is comprised of a brake level, a brake cable, a cable head, a recess, and a locking base, wherein, the cable head being preset in the recess of the brake level, an arch contact being provided in the recess of the brake level, the brake cable lying flushed over the arch contact in the course of applying a hand brake; and
the brake cable being pulled on the same axis when the brake level being turned.
